(19) United States
(12) Patent Application Publication
(10) Pub. No.: US 2004/0207603 A1
(43) Pub. Date: Oct. 21, 2004

(54) Third shaft structure of a cursor input device

(75) Inventor: Heng-Liang Lin, Taipei (TW)

Correspondence Address: ARENT FOX KINTNER PLOTKIN & KAHN, PLLC, Suite 400, 1050 Connecticut Avenue, N.W., Washington, DC, 20036-5339, US

(73) Assignee: CHICONY ELECTRONICS CO. LTD

(21) Appl. No.: 10/627,924

(22) Filed: Jul. 28, 2003

(30) Foreign Application Priority Data
Apr. 15, 2003 (TW) 92205885

(51) Int. Cl. G09G 5/08

(52) U.S. Cl. 345/164

(57) ABSTRACT

A third shaft structure of a cursor input device comprises a scroll wheel and a support base. The support base consists of a coupling portion, a round-shaped groove, a scroll wheel shaft and an elastic arm, wherein a plurality of π-shaped channeling grooves are disposed on both sides of the coupling portion. The round-shaped groove, horizontally placed between the π-shaped channeling rods of the coupling portion, is extended forward to form a scroll wheel shaft. The elastic arm has a fixed end and a free end, with the fixed end being connected to the top of the round-shaped groove while having a protruding block disposed at the front end thereof. A wheel shaft is disposed at the center of the scroll wheel that is for the scroll wheel shaft of the supporting base to interpose. An indented surface having notches, disposed on the inside of the scroll wheel, is for the protruding block on the free end of the elastic arm to prop against, such that a segmented sensation is caused to the user while the scroll wheel is rotated upwards and downwards.

### BACKGROUND OF THE INVENTION

1. Field of the Invention

The present invention relates to a third shaft structure of a cursor input device, more particularly, a third shaft structure of a cursor input device comprising an elastic arm integrally formed with the scroll wheel shaft, thus causing a segmented sensation to the user while the wheel is rotated upwards and downwards.

2. Description of the Prior Art

The case of R.O.C. patent No. 88200775 disclosed a structural improvement of the third shaft input device of a mouse. The mouse comprises a base, a circuit board, a track ball mechanism, a third shaft input device and a cover, wherein two supporting racks with certain distance in-between are mounted onto the mouse's base, wherebetween an integrally formed third shaft input device is disposed, comprising a scroll wheel, two pivot shafts respectively extending from two sides of the scrolling wheel so as to pivotally connect with the two supporting racks. One side of the shaft connecting with the scroll wheel is integrally formed with a focus wheel located in the IR module on the base. The other side of the shaft connecting with the scroll wheel corresponds with a micro switch. In addition, the shaft on the identical side is formed integrally with a locking wheel whereon a plurality of notches and propping rods that are adjacently disposed with certain distance in-between. An engaging member elastically movable is mounted on the position of the base corresponding with the locking wheel. Thus when the scroll wheel is being rotated, the engaging member then props against the scroll wheel, enabling the user to sense the movement of the cursor with a segmented sensation due to the scroll wheel's being rotated upwards and downwards by having the pivot shaft as the axle.

Although the scroll wheel of the third shaft input device disclosed in the foregoing patent provides a segmented sense for the user while the scroll wheel is rotated upwards and downwards, the elastic engaging member and the third shaft input device are both independent members requiring numerous parts and tiresome assembling processes, as well as increasing manufacturing and material management costs.

### SUMMARY OF THE INVENTION

The present invention provides a third shaft structure of a cursor input device. With a wheel shaft and an elastic arm capable of causing a segmented sensation to the user while the scroll wheel is rotated upwards and downwards being integrally formed, the manufacturing and assembling process are simplified, and the manufacturing costs are decreased.

A third shaft structure of the cursor input device achieving the object stated above comprises a support base having a coupling portion, a round-shaped groove, a scroll wheel shaft and an elastic arm, a scroll wheel with a wheel shaft being mounted at the center thereof, an indented surface is mounted inside the scroll wheel, wherein the coupling portion, the round-shaped groove, the scroll wheel shaft and the elastic arm of the support base are integrally formed and are jointed with the scroll wheel via the scroll wheel shaft being interposing through the wheel shaft. The indented surface inside the scroll wheel is for the elastic arm to prop against, such that as the scroll wheel is rotated, a segmented sensation is caused to the user while the scroll wheel is rotated upwards and downwards.

A plurality of π-shaped channeling grooves are mounted on both sides of the coupling portion.

The round-shaped groove is horizontally disposed between the π-shaped channeling grooves of the coupling portion.

The round-shaped groove is extended forward to form a scroll wheel shaft with both sides on the front end thereof being flattened in design.

The elastic arm has a fixed end and a free end, with the fixed end being attached to the top of the round-shaped groove.

A protruding block is attached to the front end of the free end; both sides of the protruding block are biased surfaces.

The indented surface comprises flanges and concave surfaces.

### BRIEF DESCRIPTION OF THE DRAWINGS

These and other features, aspects and advantages of the present invention will become better understood with regard to the following description, appended claims and accompanying drawings that are provided only for further elaboration without limiting or restricting the present invention, where:

FIG. 1 shows a sectional block diagram of the present invention being applied to a third shaft structure in a cursor input device of a mouse;

FIG. 2 shows a sectional block diagram of a third shaft structure in a cursor input device of the present invention;

FIG. 3 shows a block diagram of the present invention being applied to a third shaft structure in a cursor input device of a mouse;

FIG. 4A shows a schematic diagram for the motion of an elastic arm in a third shaft structure of the present invention propping against the flange of a scrolling wheel; and

FIG. 4B shows a schematic diagram for the motion of an elastic arm in a third shaft structure of the present invention propping against the inside of the groove of a scrolling wheel.

### DETAILED DESCRIPTION OF THE PREFERRED EMBODIMENT

The following is a detailed description of the best presently known modes of carrying out the inventions. This description is not to be taken in a limiting sense, but is made merely for the purpose of illustrating the general principles of the inventions.

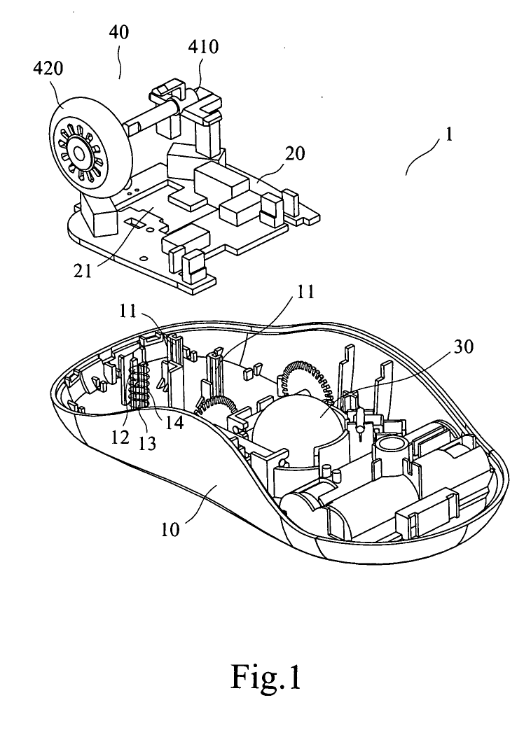

See FIG. 1, which shows a sectional block diagram of the present invention being applied to a third shaft structure in a cursor input device of a mouse. A third shaft structure 1 in a cursor input device of a mouse comprises a base 10, a circuit board 20, a track ball mechanism 30 and a third shaft structure 40. The base 10 is disposed on one side of the front end thereof with a plurality of π-shaped channeling rods 11 whereas a supporting rod 12 is disposed on the other end of the front end thereof. A blocking rod 13 is disposed on the middle portion of the supporting rod 12, with the height thereof being lower than that of the supporting rod 12. The supporting rod 12 becomes elastic as an elastic element 14 wraps around the periphery of the supporting rod 12. The circuit board 20 is disposed at the front end of the base 10 and is mounted with a piercing hole 21 for corresponding to the locations of the plurality of π-shaped channeling rods 11 and the supporting rod 12 of the base 10, such that the plurality of π-shaped channeling rods 11 and the supporting rod 12 of the base 10 may interpose through the piercing hole 21 of the circuit board 20. The circuit board 20 is further disposed with a plurality of micro switches. The track ball mechanism 30, disposed at the rear end of the base 10, comprises connecting elements such as a track ball and a focus wheel. The third shaft structure 40 having a support base 410 and a scroll wheel 420 is in accordance with the plurality of π-shaped channeling rods 11 and the supporting rod 12 that interpose through the piercing hole 21 of the circuit board 20 and connects therewith.

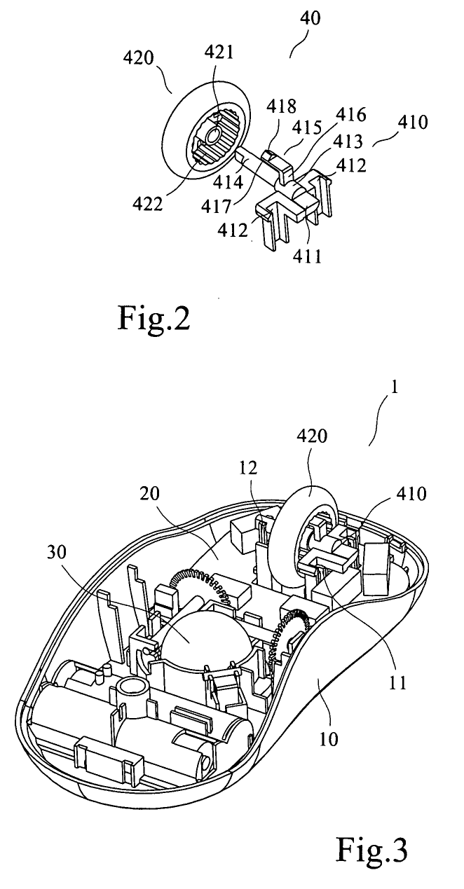

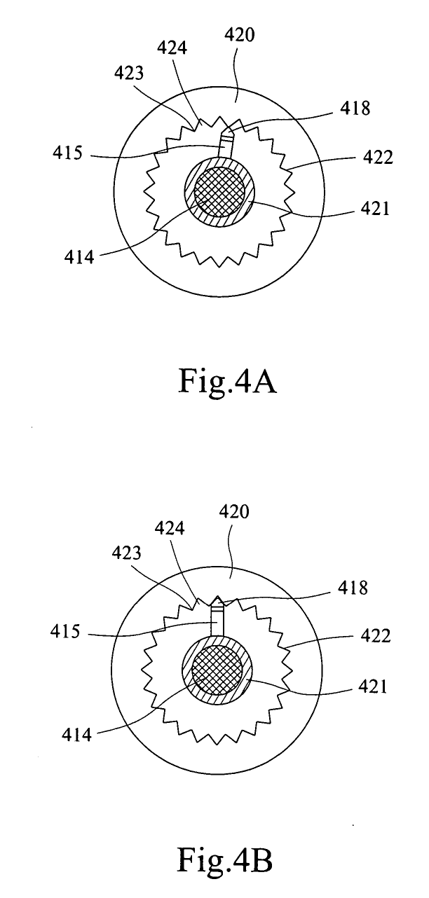

See FIG. 2, which shows a sectional block diagram of a third shaft structure in a cursor input device of the present invention. The third shaft structure 40 of the cursor input device 1 of the present invention comprises a support base 410 and a scroll wheel 420, wherein the support base 410 integrally formed comprises a coupling portion 411, a round-shaped groove 413, a scroll wheel shaft 414 and an elastic arm 415. A plurality of π-shaped channeling grooves 412 are mounted on both sides of the coupling portion 411 which corresponds and couples with the plurality of the π-shaped channeling rods 11. The round-shaped groove 413 is horizontally placed between the π-shaped channeling grooves 412 of the coupling portion 411. The round-shaped groove 413 extends forward so as to form a scroll wheel shaft 414, with both sides on the front thereof being flattened to respectively form a flat surface. The elastic arm 415 has a fixed end 416 and a free end 417, with the fixed end 416 being integrally connected to the top of the round-shaped groove 413. The front end of the free end 417 is disposed with a protruding block 418 with both sides thereof being biased surfaces. The scroll wheel 420 has a wheel shaft 421 mounted on the center thereof, which is to be interposed by the scroll wheel shaft 414 of the support base 410. An indented surface 422 having notches is mounted inside the scroll wheel 420, and the indented surface 422 contains a flange 423 and a groove 424 (see FIGS. 4A and 4B). The indented surface 422 of the scroll wheel allows the protruding block 418 of the free end 417 of the elastic arm 415 to prop against, so as to provide the user with segmented sensation as the scroll wheel 420 is rotated upwards and downwards.

See FIG. 3, which shows a block diagram of the present invention being applied to a third shaft structure in a cursor input device of a mouse, in accordance with FIGS. 1 and 2. When assembling a mouse, the track ball mechanism 30 is placed on the rear end of the base 10, and then the piercing hole 21 of the circuit board 20 is interposed by the π-shaped channeling rods 11 and the supporting rod 12, such that the circuit board 20 is placed at the front end of the base 10. Subsequently, the scroll wheel shaft 414 of the support base 420 is to interpose through the wheel shaft 421 of the scroll wheel 420 such that the scroll wheel 420 is placed on the scroll wheel shaft 414 of the support base 410, and the elastic arm 415 of the support base 410 is to prop against the indented surface 422 having notches inside the scroll wheel 420, so as to form the third shaft structure 40 of the present invention. Then the π-shaped channeling rods 11 of the support base 410 are to correspond, engage and fasten with the π-shaped supporting rod 12, with the flattened surfaces at the front end of the scroll wheel shaft 414 being engagingly placed on the middle section of the supporting rod 12 and on top of the elastic element 14, such that the scroll wheel shaft 414 may be motioned upwards and downwards via the elastic force of the elastic element 14, and is prevented from being moved downwards as the blocking rod 13 is to prop against the scroll wheel shaft 414 of the support base 410 when the scroll wheel 420 is pressed. At this time a certain distance is formed between the scroll wheel 420 and the circuit board 20 on the base 10 since the scroll wheel 420 is supported by the support base 410 and the supporting rod 12, such that the scroll wheel 420 can be rotated. Finally, an upper cover is applied thereon so as to complete the assembling process of a mouse.

See FIGS. 4A and 4B, which show schematic diagrams for the motion of an elastic arm in a third shaft structure of the present invention. Since the elastic arm 415 of the support base 410 props against the flange 423 of the indented surface 422 on the scroll wheel 420 (As shown in FIG. 4A), as the user rotates the scroll wheel 420, and once the flanges 423 of the indented surface 420 come into contact with the elastic arm 415 of the support base 410, a sensation of lifting upwards is cause to the hand of the user holding the mouse. While the scroll wheel 420 continues to be rotated, the elastic arm 415 is to slide from the flanges 423 of the indented surface 422 into the groove 424 of the indented surface 422 (As shown in FIG. 4B), so as to cause the hand of the user on the scroll wheel 420 a sensation of pulling downwards. Hence, as the user rotates the scroll wheel 420, a segmented sensation is caused as the scroll wheel 420 is rotated upwards and downwards and the movement of the cursor is sensed.

Although the present invention has been described in considerable detail with reference to certain preferred embodiments thereof, those skilled in the art can easily understand that all kinds of alterations and changes can be made within the spirit and scope of the appended claims. For example, the application of the third shaft structure of the cursor input device of the present invention should not be limited to computer mice, since keyboards having the cursor input device or contact-control panels, controllers of video games may also apply the present invention. Therefore, the spirit and scope of the appended claims should not be limited to the description of the preferred embodiments contained herein.

What is claimed is:

1. A third shaft structure of a cursor input device comprising:
a base,
a circuit board,
a track ball mechanism; and
a third shaft structure, comprising:
a support base having a coupling portion, a round-shaped groove, a scroll wheel shaft and an elastic arm; and
a scroll wheel having the center thereof being disposed with a wheel shaft, an indented surface being disposed inside said scroll wheel;
wherein said coupling portion, said round-shaped groove, said scroll wheel shaft and said elastic arm of said supporting base being integrally formed and being jointed with said scroll wheel by said scroll wheel interposing through said wheel shaft of the scroll wheel, said indented surface of said scroll wheel being for said elastic arm to prop against, so as to cause a segmented sensation as said scroll wheel being rotated upwards and downwards.

2. The third shaft structure of the cursor input device as in claim 1, wherein a plurality of π-shaped channeling grooves are mounted on both sides of said coupling portion.

3. The third shaft structure of the cursor input device as in claim 1, wherein the round-shaped groove is horizontally placed in-between said π-shaped channeling grooves on said coupling portion.

4. The third shaft structure of the cursor input device as in claim 3, wherein said round-shaped groove is extended forward to form a scroll wheel shaft with two sides of the front end thereof being flattened respectively to form two flat surfaces.

5. The third shaft structure of the cursor input device as in claim 1, wherein said elastic arm has a fixed end and a free end, with said fixed end being connected to the top end of said round-shaped groove.

6. The third shaft structure of the cursor input device as in claim 5, wherein a protruding block is mounted at the front end of said free end, with both sides of said protruding block being formed as biased surfaces.

7. The third shaft structure of the cursor input device as in claim 1, wherein said indented surface has flanges and concave surfaces.
